(19) United States
(12) Patent Application Publication
(10) Pub. No.: US 2003/0023639 A1
(43) Pub. Date: Jan. 30, 2003

(54) Application generator for creating web pages

(75) Inventors: Kung Chen, Taiwan (CN); Chih-Shyang Chang, Taiwan (CN)

Correspondence Address: OSTROLENK FABER GERB & SOFFEN, 1180 AVENUE OF THE AMERICAS, NEW YORK, NY, 100368403

(73) Assignee: Openpath Software Corp.

(21) Appl. No.: 09/824,999

(22) Filed: Apr. 3, 2001

(51) Int. Cl. G06F 17/24; G06F 17/21

(52) U.S. Cl. 707/530

(57) ABSTRACT

An application generator for creating web pages comprises: a toolbar having a plurality of control items for a user to select and edit, wherein each control item of the toolbar is GUI (graphical user interface) represented; a translator for converting every GUI represented control item into a correspondent intermediate representation; a representation-mapping table ruling conversion of the intermediate representation into the DHTML (Dynamic HyperText Mark-up Language) represented control item; a logical-part mapping table ruling conversion of the intermediate representation into an event handler and a statement; and a generator for creating a DHTML representation and an event handler as well as a statement combined therewith from a GUI represented control item according to the representation-mapping table and the logical-part mapping table.

### FIELD OF THE INVENTION

This invention relates generally to web-page edition tools, more particularly, it relates to an application generator for creating web pages by way of dragging control components and form-based method on the basis of the existing Windows application development tools.

### BACKGROUND OF THE INVENTION

When producing a web page in early days, the text editor was considered the most prevalent tool applied for editing a DHTML (Dynamic HyperText Markup Language) based web page that would cost people too much time.

Recently, some graphical tools for production of web-page application more conveniently are available, however, most of them are content-based such that a user better be familiar with the DHTML or he may develop an imperfect application system that requires funny repetitive operation of page switch or scroll bar for example, or he may find out that the maintenance is difficult and the download time is unbearable long when the edition interactive program interface of Activex Control or Java Applet is applied. On the other hand, it is a real burden and time cost for a user to learn to be master of the DHTML.

### SUMMARY OF THE INVENTION

The primary object of this invention is to create web pages via a GUI (graphical user interface) representation under Windows application development environment like the way in developing the Visual Basic.

In order to realize abovesaid object, this invention provides a web-page application generator, which comprises:

a toolbar having a plurality of control items for a user to fetch and edit, wherein each control item of the toolbar, before or after selection and edition, is GUI represented;

a translator for conversion of every GUI represented control item into a correspondent intermediate representation item;

a representation mapping table for assigning the way to make the intermediate representation conform to the rules of the DHTML (Dynamic HyperText Markup Language) so that the GUI represented control items can be converted into the DHTML represented control items according to the representation mapping table;

a logical-part mapping table for assigning the rules to convert the intermediate representation into a correspondent event handler and a statement; and

a generator for generating every DHTML represented control item and an event handler and a statement combined therewith basing on the representation-mapping table and the logical-part mapping table.

For more detailed information regarding this invention together with advantages or features thereof, at least an example of preferred embodiment will be elucidated below with reference to the annexed drawings.

### BRIEF DESCRIPTION OF THE DRAWINGS

The related drawings in connection with the detailed description of this invention, which is to be made later, are described briefly as follows, in which:

FIG. 1 shows a framework of this invention;

FIG. 2 is a schematic view showing a preferred generator of this invention run under the Visual Basic's environment; and

FIG. 3 shows an embodiment of web-page application for query of a client's fundamental information.

### DETAILED DESCRIPTION OF THE PREFERRED EMBODIMENT

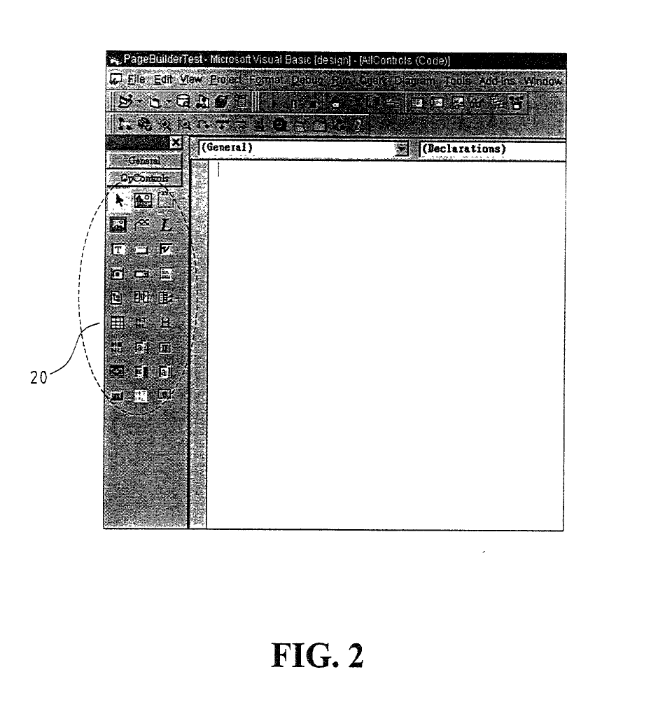

For coding an application generator of this invention for creating web pages, the existing Visual Basic or Delphi of the Windows application development tools is ready for selection. A plurality of control items (aligned in a toolbar 20 shown in FIG. 2) has been defined in their respective substantial contents by way of a GUI (graphical user interface) representation, which is taken to pair with the Windows application development tools to provide an integrated development environment. A development tool stores the content of form representation in file format, and under the Visual Basic (abbrev. as VB hereinafter) or the Delphi of the Windows application development tools, the GUI representation means the VB or the Delphi representation respectively. For example, the representation of a control item “label” implemented in the VB and the Delphi is as the following:

| “label” implemented in the VB | “label” implemented in the Delphi |
|---|---|
| Begin opcontrols.Label Label1 | Object Label: Tabel1 |
| Height = 285 | Height = 24 |
| Left = 360 | Left = 32 |
| Top = 480 | Top = 65 |
| Width = 975 | Width = 19 |
| Caption = “serial number” | Caption = “serial number” |
| End | End |

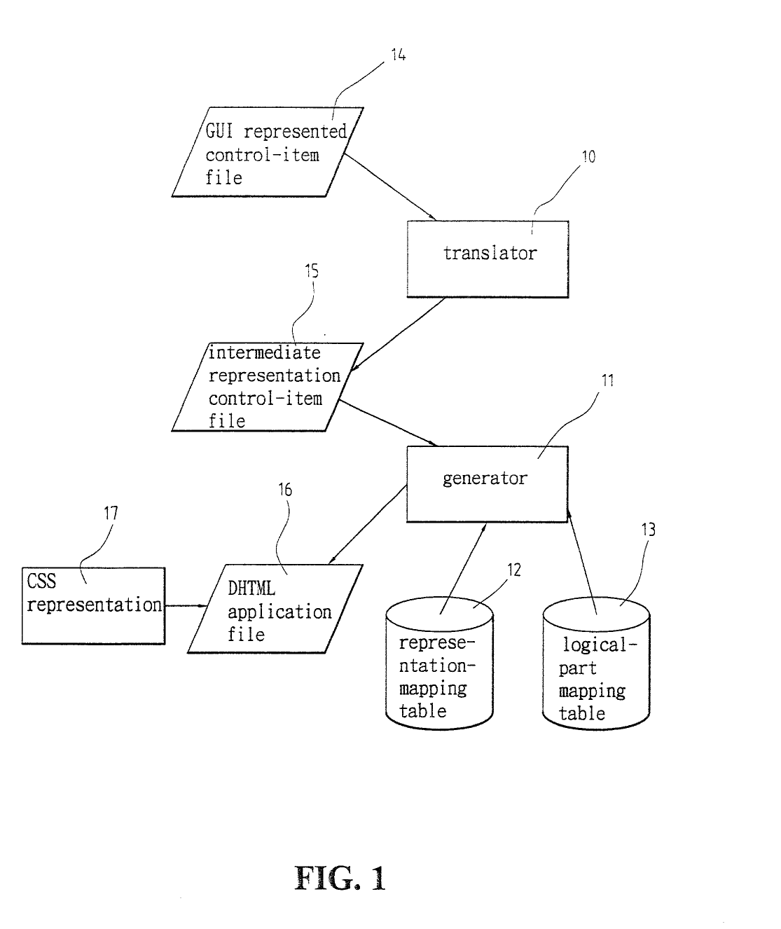

In the framework of this invention shown in FIG. 1, the stored content of a “GUI represented control-item file 14” is a plurality of GUI represented control items, which are represented by a plurality of control icons in the toolbar 20 and selected for creating a web-page application when a user is running a generator shown in FIG. 2. A translator 10 is implemented to convert every control item of the “GUI represented control-item file 14” into an “intermediate representation control-item file 15.” The generator 11 is applied according to a representation-mapping table 12 and a logical-part mapping table 13 to convert the “intermediate representation control-item file 15” into a “DHTML application file 16” which is in combination with an event handler and a statement, wherein the representation-mapping table 12 contains the rules that regulates the way a GUI represented control item can be converted into a corresponding DHTML represented control item; and the logical-part mapping table 13 contains the rules that regulates the way the intermediate representation can be converted into the event handler and the statement.

FIG. 2 illustrates a schematic view showing a preferred generator of this invention run under the Visual Basic's environment In this embodiment, a user can select the control icons aligned in the toolbar 20 and edit the content of a chosen control item for creating a web-page application by dragging in a shortest time, where the control items of this invention are capable of covering the entire range of web-page application defined by DHTML.

As the web-based applications are primarily used in the e-solution of business model, many control items are implemented here and there repetitively, therefore, some common components of this invention are fixedly formatted for saving time of system development. Besides, in consideration of flexibility for user's different requirements, this invention provides a plurality of control items as shown in the toolbar 20 in FIG. 2, which comprises:

A “label” control Hi. This control item resembles the “Label” in the Visual Basic for displaying characters and cannot be edited or amended.

A “text box” control item. This control item is to receive a user's input data or a menu data, and in addition to inheriting the attribute of “TextBox” of the Visual Basic, it contains a new additional attribute as of “Unirequired” for defining if input data are required.

A “check box” control item. This control item which inherits the attribute of “CheckBox” of the Visual Basic is provided to display an item's selection state.

An “option box” control item. This control item which inherits the attribute of “OptionButton” of the Visual Basic is provided to display the selection state of a group on one-item-one-time basis.

A “list box” control item. This control item which inherits the attribute of “ListBox” of the Visual Basic is formed in an itemized selection sheet to display one or more directory values chosen by a user and is provided with a new additional attribute as of “ItemData” for input of a selection sheet's data, wherein a space or a semi-colon is applied to space out every two batches of data.

A “combobox” control item. This control item which inherits the attribute of “ComboBox” of the Visual Basic is a downward-extensible selection sheet for input of data basing on the “ItemData” attribute.

A “sstab” control item. This control item which inherits the attribute of “SSTab” of the Visual Basic provides a simple method for offering a plurality of dialog boxes or message windows in a property sheet under a single interface. Each tab of a tab group provided by the “sstab” control item is basically a container with respect to any other control item, wherein only one tab is active to display the contained selective items while that of the rest tabs are hidden simultaneously.

A “frame” control item. This control item can be used to classify a group's control items, for example, to further divide and partition a group's option buttons.

A “command button” control item. This control item which inherits the attribute of “CommandButton” of the Visual Basic is applicable to start interrupt, or end a procedure for calling an event, a function, or a method.

A “grid” control item. This control item which inherits the attribute of “DataGrid” of the MSDataGridLib is something like a two-dimensional array TextBox for display and operation of grid data and for alignment, combination, or formation of grid's word strings.

A “tree view” control item. This control item which inherits the attribute of “TreeView” of the MSComctlLib displays knot objects in a hierarchical system, wherein each knot represents a label. The “tree view” is a typical past layer shown in a document's caption that reveals the heirachical system by adding an index, a file, a magnetic disk's directory, or other relevant information.

A “selected list” control item. This control item is a multi-selectable swapping frame, whose right end is the data selected, and input data are to be filled in the left end selection box under the attribute of “ItemData,” wherein a space or a semicolon is applied to partition two continuous batches of data, or, input data are to be filled in the right end selection box under the attribute of “ItenmData2,” wherein a space or a semicolon is applied to partition two continuous batches of data.

A “sort list” control item. This control item provides a rectangular frame for input and line-up data in orders under attribute of “Itemnata.”

A “hyperlin” control item. This control item is arranged to hyperlink words of text and provide caption for input of words to be displayed as well as “UniURL” for hyperlink route, for example, input of “http://www.ab.eom.tw/” for an absolute route.

A “menu reference” control item. This control item is provided to define a Menu bar for a web page pending creation via a Menu Editor.

A “conditional frame” control item. This control item will show a control frame if, and only if, conditions are established and set conditional operation formulas under attribute of “UniExpression” to judge its value true or false.

A “calendar box” control item. This control item offers a word frame for input of date by calling calendar to enable a user to click for input.

A “advanced text box” control item. This control item provides a word frame for query and fetches a value in the text box and runs it at a rear end to show a predetermined result.

A “html (inline HTML) input” control item. The control item allows a user to add HTML code to a file directly.

A “result table” control item. This control item is implemented in the same way with the “grid” control item except a newly added command button for controlling the first batch, the previous batch, the next batch, the last batch, and the count of batch.

A “html (external HTML) input” control item provided to “include” another executive file to the present program when running.

A “query condition frame” control item having same functionality with the “frame” control item except four additional buttons: a query button, a clear button, a newly added button, and an exit button.

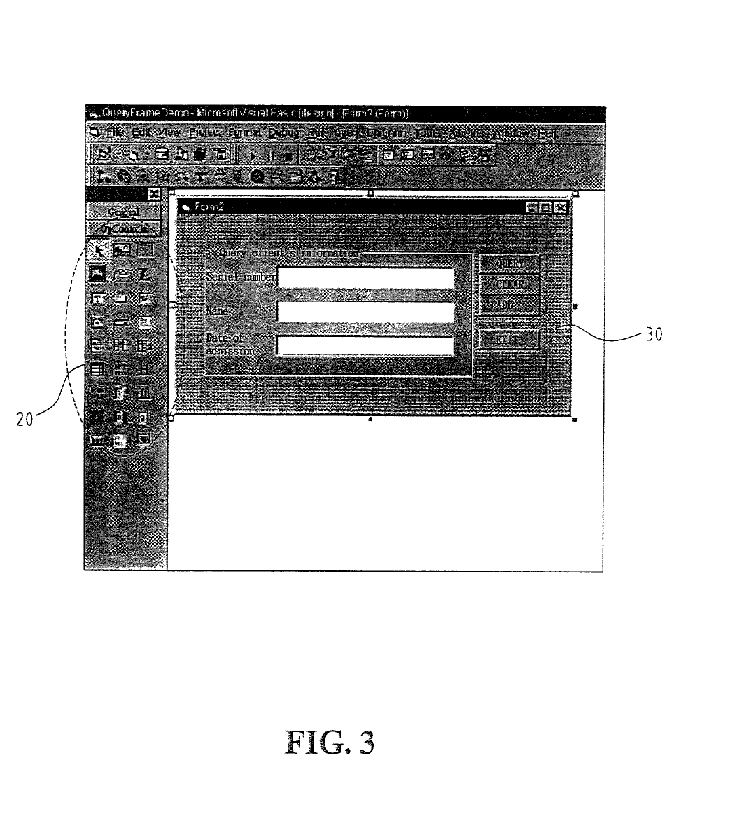

In an embodiment of web-page application for query of a clients fundamental information shown in FIG. 3, a user has chosen from the toolbar 20 a “frame” control item, three “advanced text box” control items, and four “command button” control items.

An embodiment wherein VB representation is taken on behalf of GUI representation for the “fame” control item and one of the “advanced text box” control items shown in FIG. 3 is to be described below.

The embodiment of VB representation of the “frame” control item is as the following:

| Begin opcontrols QueryConditionFrame QueryFrame1 | |
|---|---|
| Height | = 2295 |
| Left | = 720 |
| Top | = 360 |
| Width | = 6135 |
| Caption | = “Query clinet's information” |
| UniAccessKey | = ″ |
| UniDataTarget | = “MajorFrame” |
| UniOperationTarget | = “MajorFrame” |
| UniOutputStyle | = “Frame” |
| UniProgID | = ″ |
| UniCommand | = ″ |
| UniActionURL | = ″ |
| UniQueryStrings | = ″ |
| UniDialogProp | = ″ |
| UniDoesSubmitUniMSG | = “Yes” |
| Begin opcontrols.Label Label1 | |
| Height | = 285 |
| Left | = 360 |
| Top | = 480 |
| Width | = 975 |
| Alignment | = 0 |
| Caption | = “Serial number” |
| UniAccessKey | = ″ |
| End | |
| Begin opcontrols.Label Label2 | |
| Height | = 285 |
| Left | = 360 |
| Top | = 1080 |
| Width | = 855 |
| Alignment | = 0 |
| Caption | = “Name” |
| UniAccessKey | = ″ |
| End | |
| Begin opcontrols.Label Label3 | |
| Height | = 285 |
| Left | = 360 |
| Top | = 1680 |
| Width | = 855 |
| Alignment | = 0 |
| Caption | = “Date of admission” |
| UniAccessKey | = ″ |
| End | |
| End | |

The VB representation embodiment of the “advanced text box” control item is:

Begin opcontrols.TextBox CustName

Height = 375
Left = 1440
TabIndex = 2
ToolTipText = “For example: Mr. A”
Top = 960
Width = 3255
Text = “ ”
UniAccessKey = “ ”
UniRequired = 0 ‘False
Editable = ‘True

End

The VB represented control item of the web-page application for query of clients information on behalf of GUI representation shown in FIG. 3 is translated by the translator 10 into an intermediate representation embodiment as:

<XQueryConditionFrame Name=“QueryFrame1” Height=“2295”
Left=“720”TabIndex=“3”
TabStop=“0” Top=
“360” Width=“6135” Caption=“Query client's information”
UniAccessKey=“ ” UniDataTarget=“MajorFrame”
UniOperationTarget=
“MajorFrame” UniOutputStyle=“Frame” UniProgID=“ ”
UniCommand=“ ” UniActionURL=
“ ” UniQueryStrings=“ ” UniDialogProp=“ ”
UniDoesSubmitUniMSG=“Yes”>
<XLabel Name=“Label1”Height=
“285”Left=“360” Top=“480” Width=“975”
Alignment=“0” Caption=“Serial number” UniAccessKey=“ ”/>
<XLabel Name=
“Label2” Height=“285” Left=“360” Top=“1080” Width=“855”
Alignment=“0” Caption=“Name” UniAccessKey=“ ”/>
<XLabel Name=
“Label3” Height=“285” Left=“360” Top=“1680” Width=“855”
Alignment=“0” Caption=“Date of admission” UniAccessKey=“ ”/>
<XTextBox Name=“CustNo” Height=“375” Left=“1440” TabIndex=“1”
ToolTipText=“ [symbol]
: A1234567” Top=“360” Width=“3255” Text=“ ” UniAccessKey=“ ”
UniRequired=“0” Editable=“−1”/>
<XTextBox Name=
“CustName” Height=“375” Left=“1440” Tablndex=“2”
ToolTipText=“ [symbol]
: [symbol] ” Top=
“960” Width=“3255” Text=“ ” UniAccessKey=“ ” UniRequired=“0”
Editable=“−1”/>
<XTextBoxName=
“StartDate” Height=“375” Left=“1440” TabIndex=“3”ToolTipText=“ [symbol]
: 2000/11/12” Top=“1560” Width=“3255” Text=“ ” UniAccessKey=“ ”
UniRequired=“0” Editable=“−1”/>
</XQueryConditionFrame>

Above intermediate representation of tile web page shown in FIG. 3—“query for client's fundamental information”—is converted by the generator 11 according to the representation-mapping table 12 and the logical-part mapping table 13 into a corresponding web-page application in DHTML as the following:

<!−− Begin: QueryconditionFrame −−>
<TABLE BORDER=0 TD=QueryFrame1 ACCESSKEY=“ ”
STYLE=“position:absolute;height:153px;left:24px;top:48px;width:345px;”
CELLSPACING=0 CELLPADDTNG=0>
<TR>
<TD HEIGHT=20 WIDTH=10 CLASS=cSYS_FrameLeft>&nbsp;</TD>
<TD NOWRAP CLASS=cSYS_FrameCaptionBG><SPAN
CLASS=cSYS_FrameCaption>Query
client's information </SPAN></TD>
<TD CLASS=cSYS_FrameRight WDTH=“*”>&nbsp;</TD>
</TR>
<TR>
<TD CLASS=cSYS_FrameBody COLSPAN=3 HEIGHT=“*”>&nbsp;
<SPAN ID=Label1 ACCESSKEY=“ ” CLASS=cSYS_Label
STYLE=“position:absolute;left:24px;top:32px;“>Serial number</SPAN>

.
.
.

<INPUT TYPE=TEXT ID=CustNo TABINDEX=1 ACCESSKEY=
“ ”TITLE=“Example: A1234567”
CHECKED=0 CLASS=cSYS_TextBox
STYLE=“position:absolute;width:217px;left:96px;top:24px;”VALUE=“ ”
ONCHANGE=“textBox_onChange(this);”ONBLUR=
“textBox_onChange(this);”
ONMOUSEOUT=“textBox_onChange(this);”>
<INPUT TYPE=TEXT ID=CustName TABINDEX=2 ACCESSKEY=
“ ” TITLE=“For example:
Mr. A”CHECKED=0 CLASS=cSYS_TextBox
STYLE=“position:absolute;width:217px;left:96px;top:64px;“VALUE=“ ”
ONCHANGE=“textBox_onChange(this);” ONBLUR=
“textBox_onChange(this);”
ONMOUSEOUT=“textBox_onChange(this);”>

.
.
.

</TD>
</TR>
</TABLE>
<TABLE BORDER=0 CELLSPACING=0 CELLPADDING=0
STYLE=“position:absolute;top:
48px;left:373px;height:153px;width:60px;”>
<TR>
<TD ALIGN=CENTER VALIGN=TOP><INPUT TYPE=
BUTTON ID=QueryFrame1_Query
CLASS=cSYS_QueryButton VALUE=“QUERY”
ONCLICK=“QueryFrame1_Cmd_onClick(‘Query’);”>
<INPUT TYPE=BUTTON ID=
QueryFrame1_Clear CLASS=cSYS_QueryButton
VALUE=“CLEAR” ONCLICK=
“QueryFrame1_Cmd_onClick(‘Clear’);”>
<INPUT TYPE=BUTTON ID=
QueryFrame1_New CLASS=cSYS_QueryButton
VALUE=“ADD” ONCLICK=
“QueryFrame1_Cmd_onClick (‘New’);”><BR><BR>
<INPUT TYPE=BUTTON ID=
QueryFrame1_Exit CLASS=cSYS_QueryButton
VALUE=“EXIT” ONCLICK=“QueryFrame1_Cmd_onClick(‘Exit’);”>
</TD>
</TR>
</TABLE>&nbsp;
<!−− End: QueryConditionFrame −−>

Abovesaid example of the representation-mapping table 12 is embodied as below:

<QueryConditionFrame Family=“Frame”>
<Presentation>
<DHTML><![CDATA[
<TABLE BORDER=0 ID=$NAME$ TITLE=“$TOOLTIP$”
STYLE=“position:absolute;height:
$HEIGHT$px;width:$WIDTH$px;left:$LEFT$px;
top:$TOP$px;”CELLSPACING=0 CELLPADDING=0>
<TR>
@GetFrameCaptionLine (“$CAPTION$”) @
$CONTAINEE$
</TR>
</TABLE>
<TABLE BORDER=0 CELLSPACING=0 CELLPADDING=0
STYLE=“position:absolute:top:
$TOP$px;left:@MinusFixedLen($WIDTH$+$LEFT$,
60)@px;height:$HEIGHT$px;width:60px;”>
<TR><TD ALIGN=CENTER VALIGN=
TOP><INPUT TYPE=BUTTON ID=$NAME$_Query
CLASS=cSYS_QueryButton VALUE=“#CAP_QUERY#”
$EVENTHANDLER_ATTRIBUTES_QUERY$>
<INPUT TYPE=BUTTON ID=
$NAME$_Clear CLASS=cSYS_QueryButton
VALUE=
“#CAP_CLEAR#“$EVENTHANDLER_ATTRIBUTES_CLEAR$>
<INPUT TYPE=BUTTON ID=
$NAME$_New CLASS=cSYS_QueryButton
VALUE=“#CAP_NEW#”
$EVENTHANDLER_ATTRIBUTES_NEW$><BR><BR>
<INPUT TYPE=BUTTON ID=
$NAME$_Exit CLASS=cSYS_QueryButton
VALUE=“#CAP_EXIT#”$EVENTHANDLER_ATTRIBUTES_EXIT$>
</TD></TR>
</TABLE>&nbsp;
]]></DHTML>
</Presentation>
</QueryConditionFrame>

Abovesaid example of the logical-part mapping table 13 is embodied as below:

<QueryConditionFrame Family=“Frame”>
<Logic>
<ExtraAttribute Name=“EVENTHANDLER_ATTRIBUTES_QUERY”>
<DHTML><![CDATA[ONCLICK=
“$NAME$_Cmd_onClick(‘Query’);”]]></DHTML>
<SCRIPT><![CDATA[
/* possilbe values of cmd: Query, Clear, New, Exit */
function $NAME$_Cmd_onClick(cmd)
{
}
]]></SCRIPT>
</ExtraAttribute>
<ExtraAttribute Name=“EVENTHANDLER_ATTRIBUTES_CLEAR”>
<DHTML><![CDATA[ONCLICK=
“$NAME$_Cmd_onClick(‘Clear’);”]]></DHTML>
</ExtraAttribute>
<ExtraAttribute Name=“EVENTHANDLER_ATTRIBUTES_NEW”>
<DHTML><![CDATA[ONCLICK=
“$NAME$_Cmd_onClick(‘New’);”]]></DHTML>
</ExtraAttribute>
<ExtraAttribute Name=“EVENTHANDLER_ATTRIBUTES_EXIT”>
<DHTML><![CDATA[ONCLICK=
“$NAME$_Cmd_onClick(‘Exit’);”]]></DHTML>
</ExtraAttribute>
</Logic>
</QueryConditionFrame>

The DHTML application created by the generator 11 is further combined with a cascading style sheet (CSS) representation 17 embodied as the following:

| .cSYS_FrameLeft { | |
|---|---|
| height: | 10px; |
| border-style: | groove; |
| border-width: | 2px; |
| border-bottom: | ; |
| border-right: | ; |
| } | |
| .cSYS_FrameCaption { | |
| background: | #EBE1BB; |
| position: | absolute; |
| top: | −8px; |
| font-size: | 15px; |
| z-index: | 2; |
| } | |
| .cSYS_FrameCaptionBG { | |
| } | |
| .cSYS_FrameRight { | |
| height: | 10px; |
| border-style: | groove; |
| border-width: | 2px; |
| border-left: | ; |
| border-bottom: | ; |
| } | |
| .cSYS_FrameBody { | |
| font-family: | ‘new fine Ming font’; |
| font-size: | 15px; |
| border-style: | groove; |
| border-width: | 2px; |
| border-top: | ; |
| } | |
| .cSYS_Label { | |
| font-family: | ‘new fine Ming font’; |
| font-size: | 15px; |
| } | |
| .cSYS_TextBox { | |
| height: | 23px; |
| font-family: | ‘new fine Ming font’; |
| font-size: | 15px; |
| } | |
| .cSYS_QueryButton { | |
| font-family: | ‘new fine Ming font’; |
| background: | #E8E1BB; |
| font-size: | 15px; |
| width: | 60px; |
| height: | 23px; |
| } | |

In the above described, at least one preferred embodiment has been described in detail with reference to the drawings annexed, and it is apparent that numerous variations or modifications may be made without departing from the true spirit and scope thereof, as set forth in the claims below.

What is claimed is:

1. An application generator for creating web pages, comprising:
a toolbar having a plurality of control items for a user to select and edit, wherein every control item of the toolbar and each chosen and edited control item are GUI (graphical user interface) represented;
a translator for converting every GUI represented control item into a correspondent intermediate representation;
a representation mapping table for assigning rules to convert the intermediate representation into the DHTML (Dynamic HyperText Markup Language) representation so that the GUI represented control items can be converted into the correspondent DHTML control items;
a logical part mapping table for assigning rules to convert the intermediate representation into a correspondent event handler and a statement; and
an application generator for converting every GUI represented control item into a DHTML represented control item and a correspondent event handler as well as a statement combined therewith.

2. The application generator according to claim 1, wherein the GUI representation is substantially the Visual Basic representation.

3. The application generator according to claim 1, wherein the GUI representation is substantially the Delphi representation.

4. The application generator according to claim 1, wherein the intermediate representation conforms to XML standard.

5. The application generator according to claim 1, wherein the DHTML representation of each correspondent control item created by the generator is further combined with a cascading style sheet (CSS) representation.

6. The application generator according to claim 1, wherein the plurality of control items comprises a respective control item of:
“label,” “text box,” “check box,” “option box,” “list box,” “combobox,” “sstab,” “frame,” “command button,” “grid,” “tree view,” “selected list,” “sort list,” “hyperlink,” “menu reference,” “conditional frame,” “calendar box,” “advanced text box,” “html (incline HTML) input,” “result table,” “html (external HTML) input,” and “query condition frame.”
